(19) United States
(12) Patent Application Publication
(10) Pub. No.: US 2019/0335074 A1
(43) Pub. Date: Oct. 31, 2019

(54) ELIMINATING EFFECTS OF ENVIRONMENTAL CONDITIONS OF IMAGES CAPTURED BY AN OMNIDIRECTIONAL CAMERA

(71) Applicant: Cubic Corporation, San Diego, CA (US)

(72) Inventors: William A. Malkes, Knoxville, TN (US); William S. Overstreet, Knoxville, TN (US); Jeffery R. Price, Knoxville, TN (US); Michael J. Tourville, Lenoir City, TN (US)

(21) Appl. No.: 16/395,019

(22) Filed: Apr. 25, 2019

Related U.S. Application Data
(60) Provisional application No. 62/664,031, filed on Apr. 27, 2018.

(51) Int. Cl. H04N 5/225; H04N 5/235; H04N 5/232

(52) U.S. Cl. CPC H04N 5/2257; H04N 5/23299; H04N 5/2354; H04N 5/22521

(57) ABSTRACT

A camera captures a reference image during a first environmental condition. Environmental information from sensors or a network source identifies a second environmental condition, during which the camera captures an environment-affected image. An environmental effect affecting the environment-affected image is identified based on a difference between the reference image and the environment-affected image. A component that mitigates the environmental effect is identified. For example, a heating element may be identified to mitigate ice or condensation. The identified component is automatically activated to mitigate the environmental effect on future images captured by the camera during the second environmental condition.

### CROSS-REFERENCE TO RELATED APPLICATIONS

The present disclosure claims the priority benefit of U.S. provisional application 62/664,031 filed Apr. 27, 2018 and titled “System and a Method of Eliminating Effects of Environmental Conditions on Images Captured by an Omnidirectional Camera,” the disclosure of which is incorporated herein by reference.

### 1. FIELD OF THE DISCLOSURE

The present disclosure generally relates to cameras, and more particularly relates to reduction of adverse effects of environmental conditions on images captured by cameras.

### 2. DESCRIPTION OF THE RELATED ART

Traffic signals are used to control and guide movement of traffic. The traffic signals are generally installed at intersections of roads and pedestrian crosswalks. The traffic signals sometimes include or are coupled to cameras for recording images/videos of vehicles driving along thoroughfares such as roads, especially in locations where accidents are likely, such as busy high-traffic intersections. Wide-angle lens cameras or omnidirectional cameras are used for capturing a broader field of view, which may be particularly useful in a traffic context to see and track as many vehicles as possible for as long as possible.

Various challenges are faced in capturing image using cameras. Some of these challenges are caused by environmental conditions, such as rain, intense sunshine, snow, ice, and other inclement weather conditions. Quality of images captured during such adverse environmental conditions are generally degraded in clarity or otherwise due to the obstructions, poor lighting, poor clarity, or other effects caused by the environmental conditions. For example, rain, snow, ice, or dust accumulated on a lens of a camera typically reduces image clarity or otherwise reduces image quality. There is a need, then, to mitigate the effects of environmental conditions on images captured by cameras.

### BRIEF DESCRIPTION OF THE DRAWINGS

FIG. 1 is a network architecture diagram illustrating an exemplary control system for reducing or eliminating effects of environmental conditions on images captured by a camera.

FIG. 2 is a block diagram illustrating different exemplary components of the control system.

FIG. 3 is a flow diagram illustrating exemplary operations of the smart traffic camera module for identifying an environmental condition.

FIG. 4A is a first portion of a flow diagram illustrating exemplary operations by the condition check module for image analysis and environmental condition analysis.

FIG. 4B is a second portion of the flow diagram of FIG. 4A illustrating exemplary operations by the condition check module for image analysis and environmental condition analysis.

FIG. 5 is a flow diagram illustrating exemplary operations by the notification routing module for identifying an action or component associated with mitigating an effect of a particular environmental condition affecting a particular image captured by the camera.

FIG. 6 is a flow diagram illustrating exemplary operations for eliminating effects of environmental conditions on images captured by a camera.

FIG. 7 is a flow diagram illustrating exemplary operations for activation of components that reduce environmental effects affecting images captured by a camera.

FIG. 8 illustrates an exemplary camera device including various components that mitigate effects of different environmental conditions on images captured by the camera device.

FIG. 9 is a block diagram of an exemplary computing device that may be used to implement some aspects of the image correction technology.

### DETAILED DESCRIPTION

A camera captures a reference image during a first environmental condition. Environmental information from sensors or a network source identifies a second environmental condition, during which the camera captures an environment-affected image. An environmental effect affecting the environment-affected image is identified based on a difference between the reference image and the environment-affected image. A component that mitigates the environmental effect is identified. For example, a heating element may be identified to mitigate ice or condensation. The identified component is automatically activated to mitigate the environmental effect on future images captured by the camera during the second environmental condition.

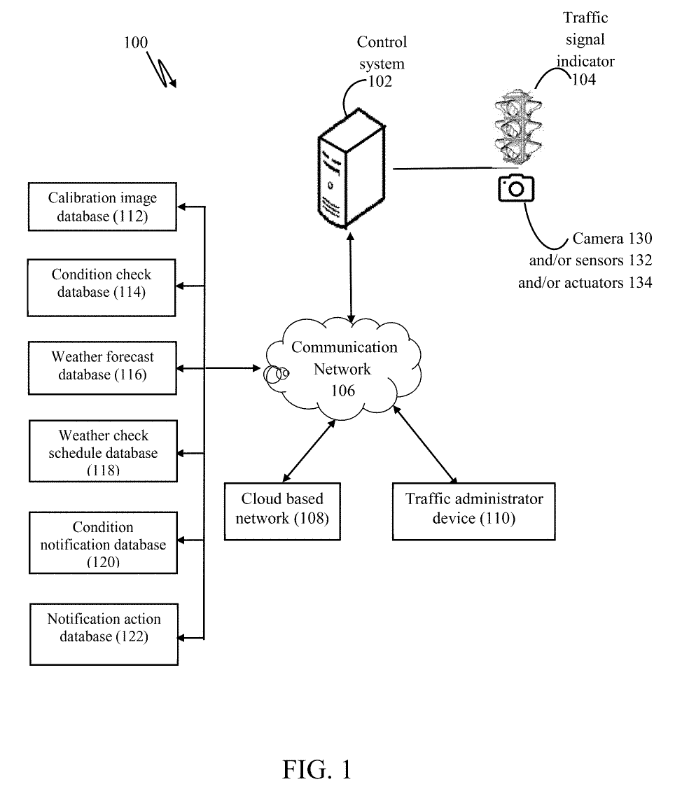

FIG. 1 is a network architecture diagram illustrating a system for reducing or eliminating effects of environmental conditions on images captured by a camera.

The control system 102 eliminates effects of environmental conditions on images, videos, and/or other visual media captured by an omnidirectional camera. The control system 102 may be implemented at a traffic signal indicator 104 or may be electrically and/or communicatively coupled to the traffic signal indicator 104. The control system 102 may be electrically and/or communicatively coupled to a camera 130 and/or various sensors 132 and/or various actuators 134. Any or all of these may be or electrically and/or communicatively coupled to the traffic signal indicator 104, or part of the traffic signal indicator 104. Further, the control system 102 may be connected to a communication network 106.

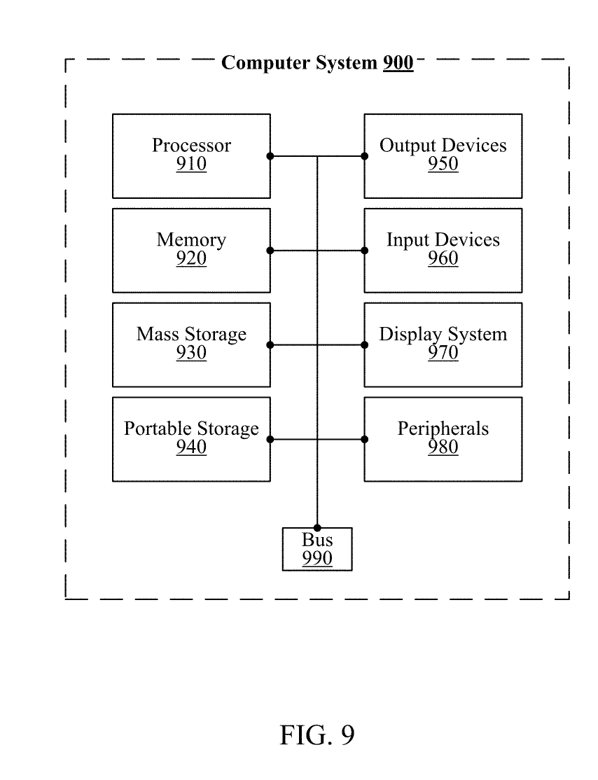

The communication network 106 may be a wired and/or a wireless network. The communication network 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, vehicle-to-vehicle (V2V), vehicle-to-infrastructure (V2I), and/or infrastructure-to-vehicle (I2V) communications, dedicated short range communication (DSRC) wireless signal transfer, any communication technologies discussed with respect to the output devices 950 of FIG. 9, any communication technologies discussed with respect to the input devices 960 of FIG. 9, or any combination thereof.

In one embodiment, the communication network 106 may also connect to a cloud based network 108. One or more embodiments may be implemented in the cloud based network 108, for example, one or more databases used with the system 102 may be implemented over the cloud based network 108. Further, the system 102 may also be connected with a traffic administrator device 110, through the communication network 106.

In one embodiment, the system 102 may be connected with a plurality of databases for receiving and storing different information required to eliminate effects of environmental conditions on images captured by an omnidirectional camera. The plurality of databases may comprise a calibration image database 112, condition check database 114, weather forecast database 116, weather check schedule database 118, condition notification database 120, and a notification action database 122.

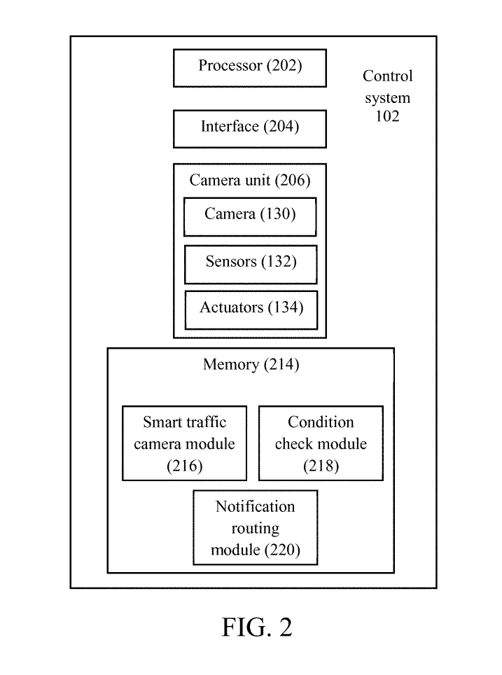

FIG. 2 is a block diagram illustrating different components of the control system.

The block diagram of FIG. 2 shows different components of the control system 102. The control system 102 comprises a processor 202, an interface 204, and a camera unit 206. The camera unit 206 may comprise a camera 130, sensors 132, and actuators 134.

The camera unit may refer to a housing present around the camera 130. While the term “camera 130” is singular, it should be understood to refer to one or more cameras 130. Any of the cameras 130 may be visible light cameras, infrared/thermal cameras, ultraviolet cameras, cameras sensitive to any other range along the electromagnetic spectrum, night vision cameras, or a combination thereof. The cameras 130 and/or sensors 132 as referred to herein may also include range measurement devices, such as light detection and ranging (LIDAR) transceivers, radio detection and ranging (RADAR) transceivers, electromagnetic detection and ranging (EmDAR) transceivers using another range along the electromagnetic spectrum, sound detection and ranging (SODAR) transceivers, sound navigation and ranging (SONAR) transceivers, or combinations thereof. Each camera 130 and/or range measurement device may be used to measure positions and/or speeds of vehicles along the thoroughfare(s) within a field of view of the respective camera 130 and/or range measurement device. The sensors of the control system 102 may also include a Visual Average Speed Computer And Recorder (VASCAR) sensor or other sensor for tracking locations and/or speeds of vehicles. Each camera 130 may be a wide-angle lens camera, an omnidirectional camera, a fisheye camera, or some combination thereof.

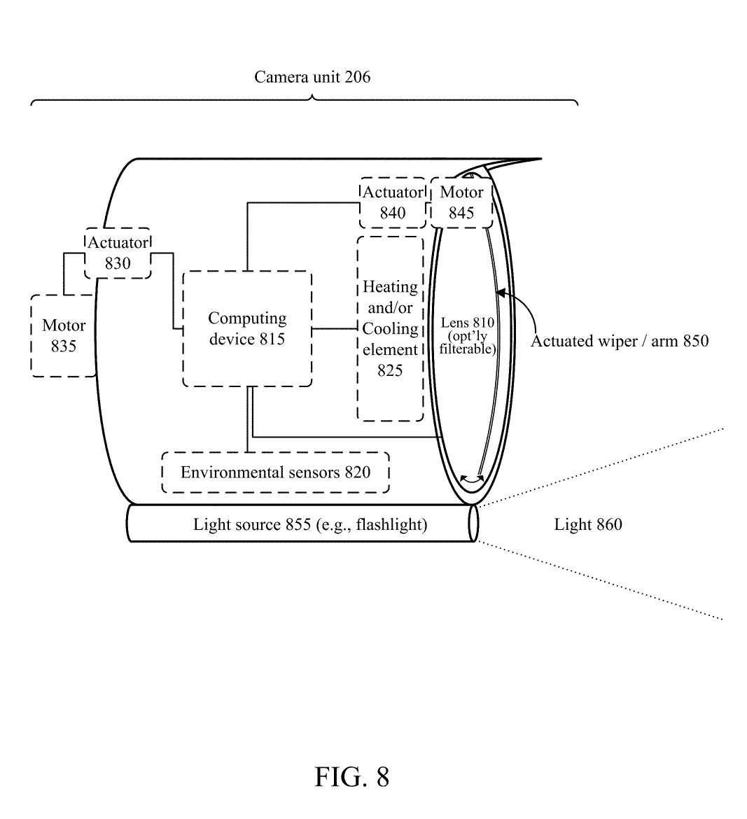

The sensors 132 may refer to different sensors, such as temperature sensors, mist sensors, rain sensors, and optical sensors. The actuators 134 may refer to different physical elements, such as a heating element, a cooling element, a motor actuator, a lens filter, and a wiping element. The system 102 further comprises a computing device with a memory 214 and a processor 202. The processor 202 may execute an algorithm stored in the memory 214 for eliminating effects of environmental conditions on images captured by the camera. An exemplary camera unit 206 with a camera 130, sensors 132 actuators 134, and a computing device 815 is illustrated in FIG. 8. The computing device 815 of FIG. 8 may be and/or include a computing device 900 as illustrated in and discussed with respect to FIG. 9, or may include at least a subset of components of a computing device 900. The control system 102 of FIG. 1 and FIG. 2 as a whole may likewise be and/or include a computing device 900 as illustrated in and discussed with respect to FIG. 9, or may include at least a subset of components of a computing device 900.

In one embodiment, the processor 202 may also be configured to decode and execute any instructions received from one or more other electronic devices or server(s). The processor 202 may include one or more general-purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 202 may be configured to execute one or more computer-readable program instructions, such as program instructions to carry out any of the functions described in this description. The processor 202 may alternately or additionally be or include any processor 910 as illustrated in and discussed with respect to FIG. 9.

The interface 204 may help an operator to interact with the system 102. For example, the interface(s) 204 may allow an operator to input for making modifications to the operational settings of the traffic signal indicator 104. The interface 204 of the system 102 may either accept an input from the operator or provide an output to the operator, or may perform both the actions. The interface 204 may either be a Command Line Interface (CLI), Graphical Operator Interface (GUI), or a voice interface. The interface(s) 204 may alternately or additionally be or include any input devices 960 and/or output devices 950 and/or display systems 970 and/or peripherals 980 as illustrated in and discussed with respect to FIG. 9.

The memory 214 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions. The memory 206 may alternately or additionally be or include any memory 920, mass storage 930, and/or portable storage 940 as illustrated in and discussed with respect to FIG. 9.

In one embodiment, the memory 214 may comprise modules implemented as a program. In one case, the memory 214 comprises a smart traffic camera module 216, condition check module 218, and a notification routing module 220. Functioning of a smart traffic camera module 216, the condition check module 218, and the notification routing module 220 is described henceforth.

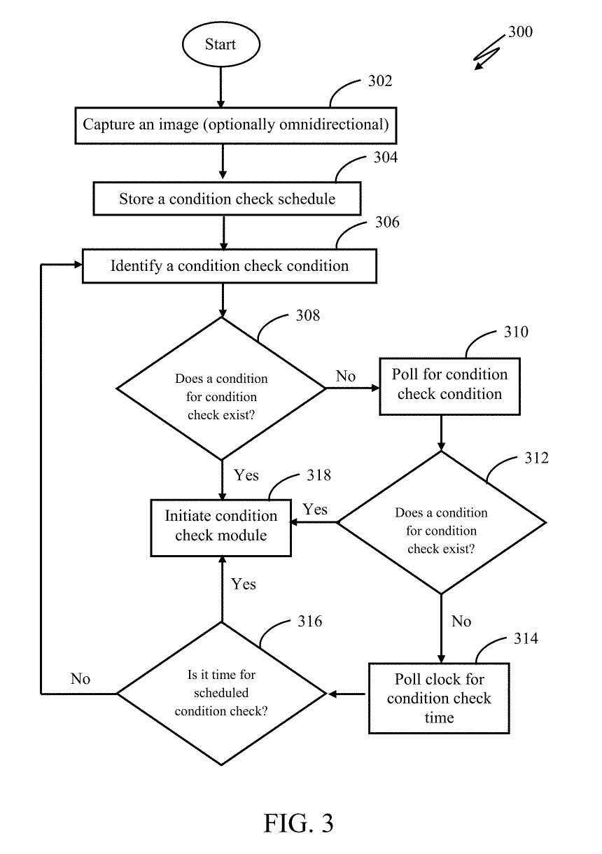

FIG. 3 is a flow diagram illustrating operations of the smart traffic camera module for identifying an environmental condition.

The flow diagram 300 of FIG. 3 identifies operations that may be executed by the smart traffic camera module 216 of FIG. 2. At first, an image of an intersection of roads may be captured using the camera 130, at step 302. In one case, the image may be stored in the calibration image database 112. Thereafter, a condition check schedule may be stored in the condition check database 114, at step 304. An exemplary representation of data stored in the condition check database 114 is illustrated below in table 1.

TABLE 1

| Date | Time | Condition |
|---|---|---|
| Jan. 2, 2017 | 5:00:00 | Image same |
| Jan. 2, 2017 | 17:00:00 | Image same |
| Feb. 2, 2017 | 5:00:00 | Image same |
| Feb. 2, 2017 | 17:00:00 | Image same |
| Mar. 2, 2017 | 5:00:00 | Image same |
| Mar. 2, 2017 | 8:00:00 | Image blurred |
| Mar. 2, 2017 | 10:15:10 | Condensation detected |
| Mar. 2, 2017 | 17:00:00 | Image same |

In the above provided table 1, column 1 lists date, column 2 contains a time of the image comparison by the condition check module 218, column 3 contains the condition of the image, that is the real-time image captured by the camera at a particular time.

In one case, the condition check schedule may be defined by a technician. Further, the condition check schedule may indicate a time or a time interval at which a condition or functioning of the omnidirectional camera may be checked. For example, the technician may set 6 AM everyday as the condition check schedule.

Post storing the condition check schedule, occurrence of a condition for condition check may be determined, at step 306. In one case, to determine occurrence of the condition for condition check, environmental sensors i.e. the sensors 132 may be polled, and the weather forecast database 116 may also be communicated. Thus, existence of a condition for condition check is determined, at step 308. In case, no such condition is found, polling for identification of the condition may be continued, at step 310. Again, existence of the condition for condition check may be determined, at step 312. If the condition is not found at step 312, dock may be polled for checking the condition check time, at step 314. Based on polling of the dock, it may be determined if a time for the scheduled condition check has occurred, at step 316. In case, the time has not occurred, the scheduled check condition may be identified again, at step 306. Further, in case of occurrence of the time for the scheduled check condition at the step 316 or existence of the condition for condition check is found at step 312, the condition check module 218 may be initiated, at step 318.

In one embodiment, the condition check database 114 may be populated with rules for conditions that trigger a check of the omnidirectional camera's condition. For example, the system 102 may check an image's condition whenever temperature drops below a freezing point, to ensure that lens of the omnidirectional camera has not been obscured with frost.

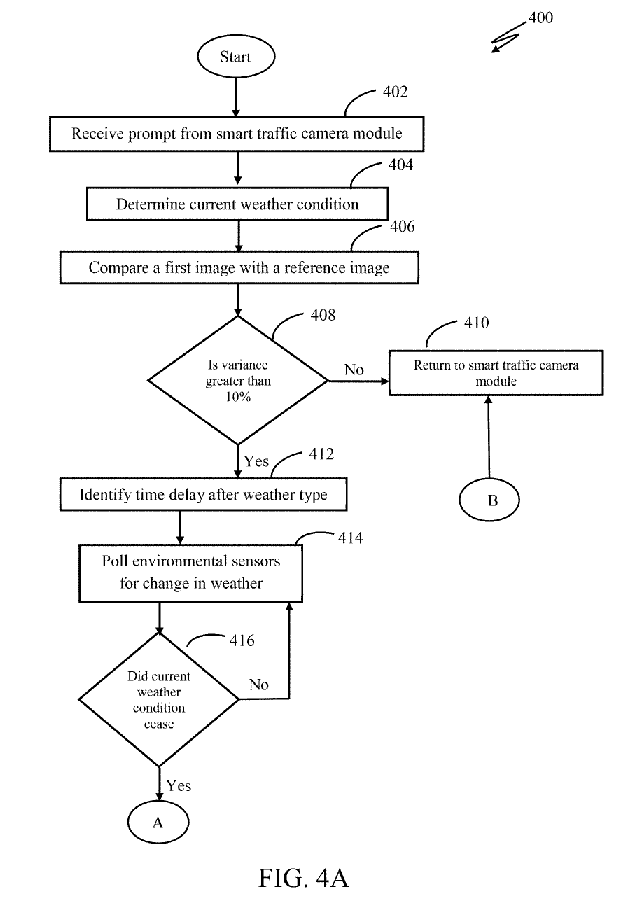

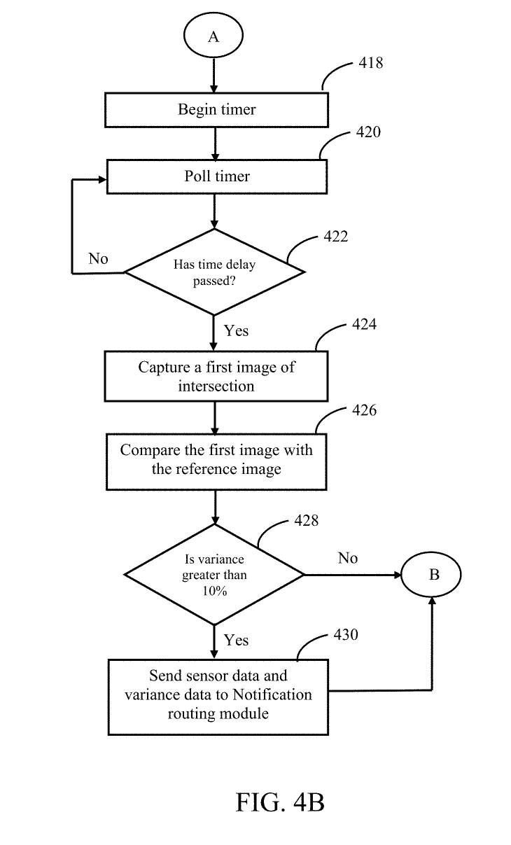

FIG. 4A is a first portion of a flow diagram illustrating operations by the condition check module for image analysis and environmental condition analysis.

The flow diagram 400 of FIG. 4A and FIG. 4B identifies operations that may be executed by the condition check module 218 of FIG. 2. At first, a prompt may be received from the smart traffic camera module 216, at step 402. Upon initiation, the condition check module 218 may identify current weather condition from the environmental sensor data, at step 404. The condition check module 218 may then capture a real-time image of the intersection. The real-time image may be compared with a reference image stored in the calibration image database 112, at step 406. The image may be compared along a number of variables; such as contrast or specific objects being visible. In one case, it would be determined if total variance across all variables is greater than 10% (arbitrarily chosen threshold), at step 408. In case value of the total variance does not exceed 10%, control may be transferred to the smart traffic camera module 216, at step 410. But, while the total variance exceeds 10%, the system 102 may identify a prescribed delay after an identified weather type from the weather check schedule database 118, at step 412. For example, the system 102 may prescribe to check lens 10 minutes after rain ceases, or to check lens 60 minutes after snow ceases. An exemplary representation of data stored in the weather check schedule database 118 is illustrated below in table 2.

TABLE 2

| Weather Condition | Condition Check Delay |
|---|---|
| Snow | 60 minutes |
| Rain | 10 minutes |
| Fog | 15 minutes |
| . . . | |
| Frost | 60 minutes |

Thereafter, the environmental sensors may be polled for determining change in the weather condition, at step 414. Based on the polling, it may be determined if the current weather condition has ceased, at step 416.

FIG. 4B is a second portion of the flow diagram of FIG. 4A illustrating operations by the condition check module for image analysis and environmental condition analysis.

While the weather condition ceases at step 416, the condition check module 218 may begin a timer, at step 418. The timer may be polled, at step 420. Based on polling of the timer, it may be determined if the time delay has passed, at step 422. Once the time delay has passed, the condition check module 218 may capture a real-time image i.e. a first image of the intersection, at step 424. The first image may be compared to the reference image in the calibration image database 112, at step 426. The first image may be compared along a number of variables; such as contrast or specific objects being visible. If the total variance across all variables is not greater than 10%, control may be transferred to the smart traffic camera module 216, at step 10. Further, if the total variance across all variables is greater than 10%, then the system 102 may collect current data from the environmental sensors and sends that data along with the image variance to the notification routing module 220, at step 430.

In one embodiment, to detect frost or condensation on the lens, the system 102 may utilize an outward facing Light Emitting Diode (LED) light that shines from the image collector out through the lens, and at the same time an image may be captured. Such procedure may help to isolate reflections of ice or water on the lens that will be captured by the light reflected back from them.

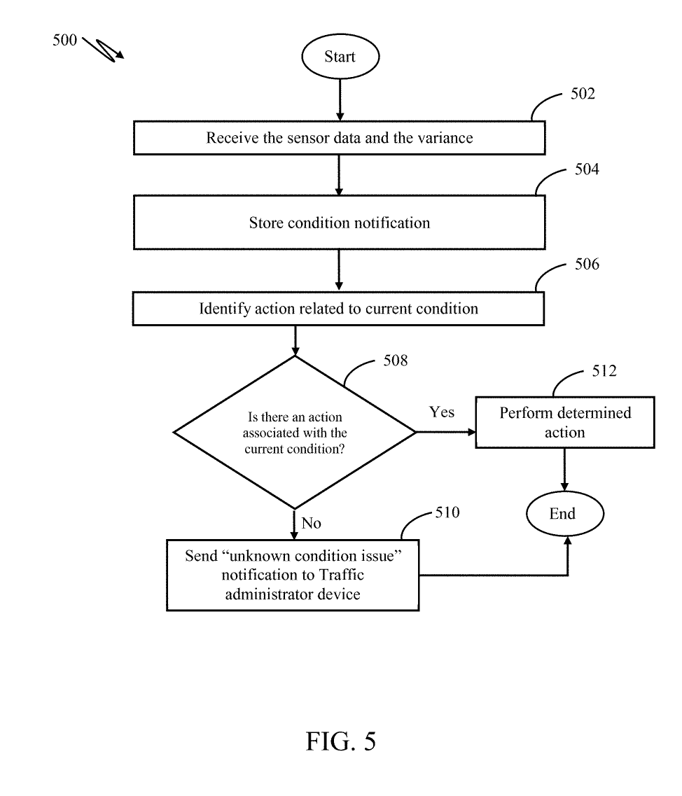

FIG. 5 is a flow diagram illustrating operations by the notification routing module for identifying an action or component associated with mitigating an effect of a particular environmental condition affecting a particular image captured by the camera.

The flow diagram 500 of FIG. 5 identifies operations that may be executed by the notification routing module 220 of FIG. 2. Sensor data and the image variance may be received from the condition check module 218 at step 502. A condition notification may be stored in the condition notification database 120 at step 504. An exemplary representation of data stored in the condition notification database 120 is illustrated below in table 3.

TABLE 3

| | Traffic | | | Type of | Image |
|---|---|---|---|---|---|
| | Signal | | | weather | Vari- |
| Date | Indicator | Time | Condition | event | ance |
| Jan. 2, 2017 | X123 | 5:00:00 | Normal | — | 0 |
| Jan. 2, 2017 | X123 | 17:00:00 | Condensation | Wind | 16% |
| | | | on lens | | |
| Feb. 2, 2017 | X345 | 5:00:00 | Normal | — | 0 |
| Feb. 2, 2017 | X345 | 17:00:00 | Normal | — | 0 |
| Mar. 2, 2017 | X567 | 5:00:00 | Normal | — | 0.01% |
| Mar. 2, 2017 | X123 | 8:00:00 | Weather | Storm | 9% |
| | | | event | | |
| Mar. 2, 2017 | X123 | 10:15:10 | Weather | Heavy | 4% |
| | | | event | rains | |
| Mar. 2, 2017 | X567 | 17:00:00 | Normal | Low | 0.32% |
| | | | | temper- | |
| | | | | ature | |

In above provided table 3, column 1 contains dates, column 2 lists the traffic signal indicator (104) from which the condition notification was received, column 3 lists the time of the comparison of image by the condition check module 218, column 4 contains the condition received from the condition check module 218, and column 5 lists the type of weather event that is stored in column 4. Column 6 contains the image variance between the reference and real-time image captured by the condition check module 218.

Thereafter, an action related to the current condition may be identified, at step 506 and step 508. The action may be retrieved from the notification action database 122. An exemplary representation of data stored in the notification action database 122 is illustrated below in table 4.

TABLE 4

| Date | Time | Condition | Action | Notification |
|---|---|---|---|---|
| Jan. 2, 2017 | 5:00:00 | Image same | — | — |
| Jan. 2, 2017 | 17:00:00 | Image same | — | — |
| Feb. 2, 2017 | 5:00:00 | Image same | — | — |
| Feb. 2, 2017 | 17:00:00 | Image same | — | — |
| Mar. 2, 2017 | 5:00:00 | Image same | — | — |
| Mar. 2, 2017 | 8:00:00 | Image blurred | Clean | Notify |
| | | | camera lens | technician |
| Mar. 2, 2017 | 10:15:10 | Condensation | Activate | Turn on lens |
| | | detected | defogging | heater |
| | | | mechanism | |
| Mar. 2, 2017 | 17:00:00 | Image same | — | — |

In above provided table 4, column 1 lists dates, column 2 contains time of the image comparison by the condition check module 218, and column 3 contains condition of the images, i.e. the real-time images captured by the omnidirectional camera at a particular time. Column 4 contains actions that need to be taken, and column 5 contains the notification that requires to be sent to the smart traffic camera module 216.

Not all conditions will have an action associated with them. If there is no action associated with the current condition, a “unknown condition issue” notification may be sent to a traffic administrator device, at step 512. It will be to the administrator's discretion what actions to take, such as dispatching a technician to the traffic light, upon receiving the notification. It is assumed that when unknown condition issues are resolved, the action to take when that condition is experienced in the future will be added to the notification action database 122. If an action associated with the current condition is found in the notification action database 122, then that action may be performed, at step 512. Such action could be performed automatically, such as turning on the heating element when condensation is detected on the lens, or a notification could be sent to the correct party, such as the administrator or a technician.

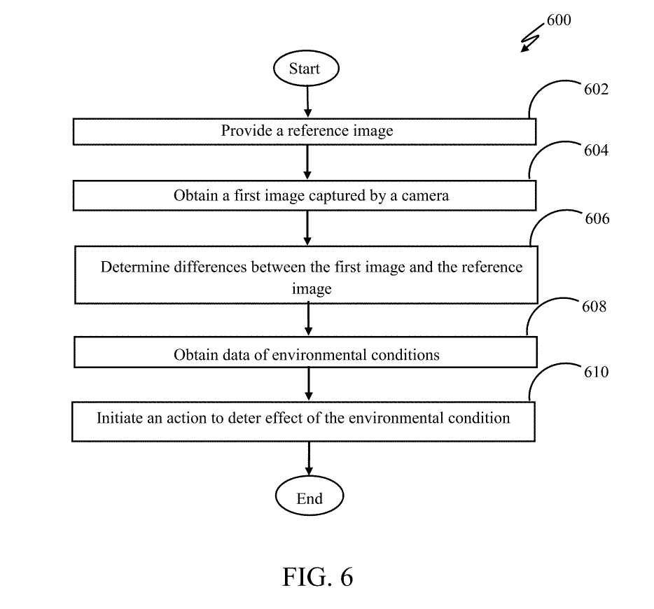

FIG. 6 is a flow diagram illustrating operations for eliminating effects of environmental conditions on images captured by a camera.

The flowchart 600 of FIG. 6 shows operations that may be executed by the control system 102 of FIG. 2. At step 602, a reference image may be provided; that is, the reference image may be captured by the camera 130 or a different camera, or may be retrieved from memory, having been previously captured by the camera 130 or a different camera. The reference image may be captured by the camera 130 or a different camera under a environmental conditions that have little effect on image quality, for example ideal sunny conditions with no rain, snow, precipitation, fog, or obstructions. As noted previously, the camera 130 may be an omnidirectional camera.

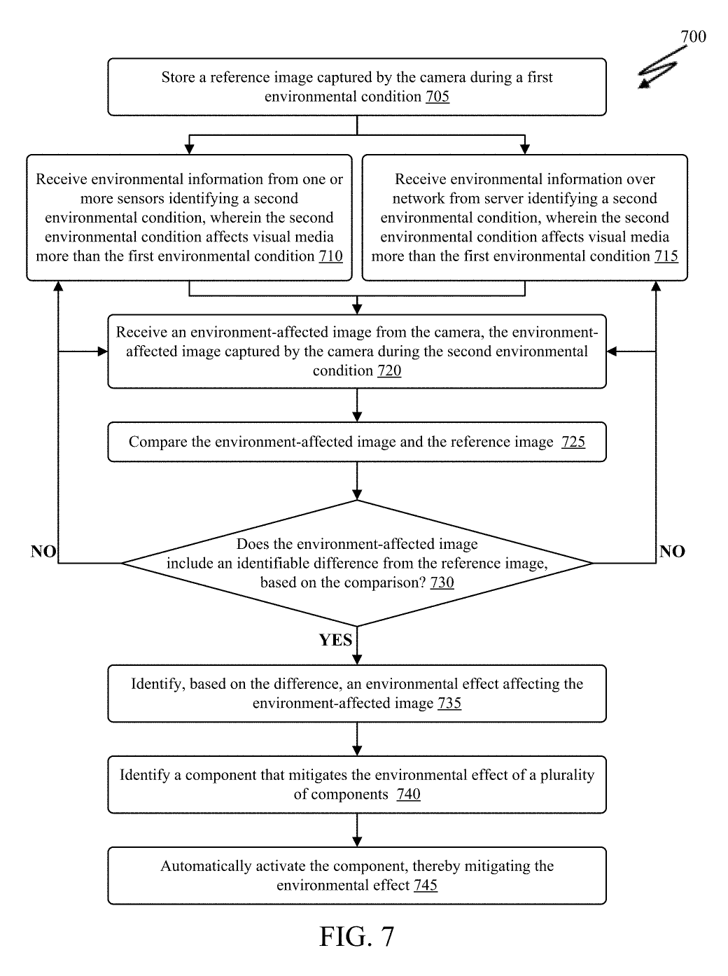

At step 604, a first image captured by the camera, in a real time, may be obtained. This first image may be captured under different environmental conditions than the reference image as explored further in FIG. 7. For example, these different environmental conditions may be worse environmental conditions (at least with respect to effect on image quality of images captured by a camera) than the environmental conditions under which the reference image was captured. The different environmental conditions of step 604 may include, for example, rain, snow, precipitation, fog, or obstructions.

At step 606, differences between the first image and the reference image may be determined upon comparison. Differences concerning appearance of different vehicles and vehicle positions, or different pedestrians and pedestrian positions, may be disregarded—instead, the differences identified may focus on differences caused by environmental effects caused by environmental conditions under which the first image was captured in step 604. For example, an environmental condition of rain or fog may result in an environmental effect of water on a lens of the camera. An environmental condition of low temperatures may result in an environmental effect of ice or snow on a lens of the camera. An environmental condition of night time may result in an environmental effect of a lower amount of light received by the camera than during day time.

At step 608, data of environmental conditions may be obtained from a sensor 132 present in the camera unit or receives over a network from one or more servers of network-based sources, such as news organizations, government agencies such as the National Weather Service (NWS) or National Oceanic and Atmospheric Administration (NOAA), weather forecasting organizations such as AccuWeather®, or combinations thereof. The environmental conditions may be found to affect clarity of images captured by the camera 130.

At step 610, an action may be initiated to deter or mitigate effect of the environmental conditions on the images captured by the omnidirectional camera. The action may be, for example, to activate a particular component via an actuator 134 of FIG. 2. For example, an environmental effect of water, ice, or snow on the lens may correspond to activation of a heating element to evaporate water or to melt ice or snow. A wiper may be activated to wipe a lens from water or other substances under conditions with regular precipitation such as rain. Further actuators 134 and components to activate are discussed with respect to FIG. 7 and FIG. 8.

FIG. 7 is a flow diagram illustrating operations for activation of components that reduce environmental effects affecting images captured by a camera.

The flow diagram 700 of FIG. 7 includes operations that may be performed by the control system 102, the camera unit 206, the computing device 815, a remote server in communicative contact with any combination of of the control system 102 and/or the camera unit 206 and/or the computing device 815, or some combination thereof.

At step 705, a reference image is stored, the reference image having been captured by the camera during a first environmental condition. The reference image may be captured by the camera 130 or a different camera, or may be retrieved from memory, having been previously captured by the camera 130 or a different camera. The first environmental condition may be one with little effect on image quality, for example ideal sunny conditions with no rain, snow, precipitation, fog, or obstructions. As noted previously, the camera 130 may be an omnidirectional camera. Step 705 may proceed to either or both of step 710 and/or step 715, or may in some cases skip directly to step 720.

At step 710, environmental information is received from one or more sensors 132 (e.g., environmental sensors 820 of FIG. 8) identifying a second environmental condition, wherein the second environmental condition affects visual media more than the first environmental condition. For example, the sensors 132 may include, for example, a moisture sensor that detects rain or high humidity, or may include a wind sensor that detects high winds, or may include an accelerometer and/or gyroscope and/or pressure sensor that detects pressure/movement caused by precipitation hitting the camera unit 206, or may include a light sensor that detects high-light or low-light conditions, or may include a thermometer (e.g., a thermistor) that detects hot temperature conditions hotter than a high-heat threshold or cold temperature conditions colder than a low-heat threshold, or some combination thereof, and may thereby identify the second environmental condition. The environmental information gathered in step 710 may include current estimates of current environmental conditions, forecasts of environmental conditions, or combinations thereof.

At step 715, environmental information is received over network from server identifying a second environmental condition, wherein the second environmental condition affects visual media more than the first environmental condition. For example, the environmental information may be received over a network from one or more servers of network-based sources, such as news organizations, government agencies such as the National Weather Service (NWS) or National Oceanic and Atmospheric Administration (NOAA), weather forecasting organizations such as AccuWeather®, or combinations thereof. Such sources may indicate, for example, that it is currently raining, or snowing, or hailing, or very cold, or very hot, or very sunny without cloud cover, or whether the sun is out or not, or whether it is icy out, or any combination thereof, this identifying the second environmental condition. This data may be determined by the network-based sources using measurements from sensors associated with the network-based sources, which may also include forecasting sensors such as Doppler Radar image data identifying storms, raindouds, humidity, and the like. The environmental information gathered in step 715, thus, may include current estimates of current environmental conditions, forecasts of environmental conditions, or combinations thereof.

In some cases, environmental information may be gathered using both the operations of step 710 and the operations of step 715 in concert. For example, Doppler Radar data from the may be retrieved (using step 715) from a service such as the National Weather Service that forecasts that a storm should start at 3:00 PM. Measurements from sensors 132 may then be received (using step 710) around 3:00 PM, for example by using feature recognition of images from the camera 130 to confirm that rain is indeed falling and that the ground is indeed wet, and by tracking a rise in moisture from a moisture sensor, and by recognizing audio corresponding to a thunder-strike recorded by a microphone of the sensors 132.

At step 720, an environment-affected image is received from the camera 130, the environment-affected image captured by the camera 130 during the second environmental condition. At step 725, the environment-affected image and the reference image are compared.

Step 730 identifies whether the environment-affected image includes an identifiable difference from the reference image, based on the comparison. If the environment-affected image includes an identifiable difference from the reference image, the process proceeds to step 735. If the environment-affected image does not include an identifiable difference from the reference image, the process instead goes back to step 705, 710, 715, 720, or 725. Differences concerning appearance of different vehicles and vehicle positions, or different pedestrians and pedestrian positions, may be disregarded—instead, the differences identified may focus on differences caused by environmental effects caused by environmental conditions under which the environment-affected image was captured and received in step 720. At step 735, based on the difference, an environmental effect is identified that affects the environment-affected image. For example, an environmental condition of rain or fog may result in an environmental effect of water on a lens of the camera. An environmental condition of low temperatures may result in an environmental effect of ice or snow on a lens of the camera. An environmental condition of night time may result in an environmental effect of a lower amount of light received by the camera than during day time.

At step 740, a component that mitigates the environmental effect is identified from a plurality of components. The components references may be the actuators 134 of FIG. 2 or may be actuated by the actuators 134 of FIG. 2. Some examples are provided in FIG. 8. For example, an environmental effect of water, ice, or snow on the lens may be mitigated by activation of a heating element to evaporate water or to melt ice or snow. An environmental effect water or other substances repeatedly/regularly appearing on the lens, such as under environmental conditions with of rain, snow, or other precipitation, may be mitigated by activation of a motorized lens wiper 850 akin to a motorized windshield wiper in an automobile. More examples of components and actuators 134 are provided in FIG. 8. The specific component that mitigates the identified environmental effect may be identified in some cases based on previously stored data identifying which components typically mitigate/alleviate, or have previously mitigated/alleviated, each of the various possible environmental effects. The previously stored data may be stored in the form of a database, table, or other data structure, and may in some cases be dynamically updated as the system 102 learns which components effectively mitigate/alleviate different environmental effects caused by different environmental conditions. At step 745, the component identified in step 740 is automatically activated, thereby mitigating the environmental effect.

While only step 740 includes the word “automatically,” it should be understood that any particular step of steps 720, 725, 730, 735, 740, and 745 may occur automatically in response to capture and/or receipt of the environment-affected image in step 720, in response to retrieval of environment information identifying the second environmental condition in step 710 and/or step 715, in response to any other step preceding the particular step, or some combination thereof.

In some cases, the difference is an image clarity difference, wherein the environmental effect is based on presence of water condensate on the camera, and wherein the component is a heating element mitigates the environmental effect by evaporating the water condensate on the camera. In some cases, the difference is an image clarity difference, wherein the environmental effect is based on presence of a substance on the camera, and wherein the component is a heating element that mitigates the environmental effect by melting the substance that is on the camera. In some cases, the difference is a brightness difference, wherein the environmental effect is based on time of day, and wherein the component is a light source that mitigates the environmental effect by illuminating a field of view of the camera. In some cases, the difference is a brightness difference, wherein the environmental effect is based on time of day, and wherein the component is a light filter that mitigates the environmental effect by reducing an amount of light received by the camera.

In some cases, the difference is an image clarity difference, wherein the environmental effect is based on presence of precipitation on the camera, and wherein the component is an actuator of a motor that mitigates the environmental effect by moving a wiper element that wipes the precipitation from the camera. In some cases, the difference is based on an occlusion of a field of view of the camera, wherein the environmental effect is based on presence of an object causing the occlusion, and wherein the component is an actuator of a motor that mitigates the environmental effect by moving the camera so as to reduce occlusion by the object in a field of view of the camera. In some cases, the difference is based on an occlusion of a field of view of the camera, wherein the environmental effect is based on presence of an object causing the occlusion, and wherein the component is an actuator of a motor that mitigates the environmental effect by moving an element that pushes the object causing the occlusion away the camera.

In some cases, the difference is an image clarity difference, wherein the environmental effect is based on presence of a substance on the camera, and wherein the component is a heating element that mitigates the environmental effect by heating the substance on the camera from a first state of matter to a second state of matter. In some cases, the difference is a brightness difference, wherein the environmental effect is based on brightness of an area in the field of view of the camera, and wherein the component is a light source illuminating the area. In some cases, the difference is a brightness difference, wherein the environmental effect is based on brightness of an area in the field of view of the camera, and wherein the component is a light filter reducing an amount of light received by the camera. In some cases, the difference is based on an occlusion of a field of view of the camera, wherein the environmental effect is based on presence of an object causing the occlusion, and wherein the component is an actuator of a motor whose actuation causes motion that reduces the occlusion.

In some cases, the difference corresponds to damage to the camera, such as a crack in the camera lens, caused by an impact to the camera, a particularly hot or cold environment, or some combination thereof. In such cases, the component may be the computing device 815 and/or processor 202, which may execute software that modifies images captured by the camera after capture to remove the crack or other damage, for example by patching in or otherwise inserting data based on the reference image, or based on neighboring image data (e.g., nearby pixels), or some combination thereof.

FIG. 8 illustrates a camera device including various components that mitigate effects of different environmental conditions on images captured by the camera device.

The camera unit 206 of FIG. 8 includes a computing device 815, which may be and/or include a computing device 900 as illustrated in and discussed with respect to FIG. 9, or may include at least a subset of components of a computing device 900. The computing device 815 may receive, capture, and/or process visual digital media data, such as images and/or videos, from one or more cameras 130 of the camera unit 206. The visual digital media data is captured based on light entering in through one or more lenses 810.

The computing device 815 of FIG. 8 is connected to various components and/or actuators 134 as discussed with respect to FIG. 7. These include, for example, a heating and/or cooling element 825, which in FIG. 8 is illustrated as residing behind the lens 810, such as one or more electric heating coils or gas-powered heating units, but may instead or additionally include components around, beside, or in front of the lens 810, such as a fan to blow hot or cool air. A heating element 825 may be actuated to melt ice or snow (or other solids) or evaporate water (or other liquids) that are present on the lens 810 or elsewhere on the camera unit 206. The cooling element 825 may be applied to the lens 810 to prevent the lens 810 from warping or cracking in high-heat situations, to the computing device 815 to prevent the processor 202 or a GPU or other component from overheating in high temperatures, to environmental sensors 820 to maintain their functionality, to an image sensor to prevent reductions in image quality that can sometimes be caused by image sensors in high-heat situations, or combinations thereof. The heating element 825 may be applied to the lens 810 to prevent the lens 810 from warping or cracking in low-heat situations, to the computing device 815 to prevent the processor 202 or a GPU or other component from underheating in cold temperatures, to environmental sensors 820 to maintain their functionality in cold temperatures, to an image sensor to prevent reductions in image quality that can sometimes be caused by image sensors in low-heat situations, or combinations thereof.

A light source 855, such as a flashlight, may be one of the components actuated. For example, if the environmental effect to be mitigated is darkness of an area in field of view of the camera 130—caused by nighttime if the area in field of view is outdoors or caused by poor illumination if the area in field of view is indoors—the light source 855 may be activated to mitigate the darkness. The light source 855 may include emitters of any wavelength or spectrum, including the visible light spectrum, the infrared light spectrum, the ultraviolet light spectrum, the radio spectrum, the microwave spectrum, the X-ray spectrum, the gamma ray spectrum, or any combination of these spectra and/or other spectra along the electromagnetic spectrum, The light source 855 may include one or more of any of the following: light-emitting diode (LED), organic light-emitting diode (OLED), polymer light-emitting diode, AMOLED, light-emitting electrochemical cell, electroluminescent wires, field-induced polymer electroluminescent, laser, chemical laser, dye laser, free-electron laser, gas dynamic laser, gas laser, ion laser, laser diode, laser flashlight, metal-vapor laser, halogen light source, incandescent light source, luminescent light source, bioluminescent light source, nonlinear optics, quantum well laser, ruby laser, solid-state laser, argand lamp, argon flash, carbide lamp, Betty lamp, butter lamp, flash-lamp, gas lighting, gas mantle, kerosene lamp, koniaphostic light, lantern, limelight, oil lamp, Tilley lamp, arc lamp, flashtube, electrostatic discharge, lightning, electric spark, gas discharge lamp, electrodeless lamp, excimer lamp, fluorescent lamp, compact fluorescent lamp, tanning lamp, black light, Geissler tube, Moore tube, “Ruhmkorff” lamp, high-intensity discharge lamp, high-intensity discharge lamp, carbon arc lamp, ceramic discharge metal-halide lamp, hydrargyrum medium-arc iodide lamp, mercury-vapor lamp, metal-halide lamp, sodium-vapor lamp, sulfur lamp, xenon arc lamp, hollow-cathode lamp, induction lighting, sulfur lamp, sulfur lamp, neon and argon lamp, dekatron, nixie tube, plasma lamp, xenon flash lamp, or any combination thereof.

The lens 810 itself may be any type of camera lens, including a fisheye lens, a wide-angle lens, a standard prime lens, a zoom lens, a macro lens, a telephoto lens, or any combination thereof. The lens 810 may be polarized and in some cases may be filterable, that is, may include a filter that may be activated that blocks or reduces some light from entering the lens 810, for example in a similar manner to sunglasses, photochromatic lenses, light-adaptive lenses, or variable tint lenses in glasses. Such filters may be activated by either actuating a motor to move a physical filter lens (similar to a sunglasses lens) over the lens 810, by rotating a second polarized lens or filter over the lens 810 to darken or lighten the image, by exposure of a photosensitive chemical such as silver chloride or copper chloride to a reagent such as UV light, which may be output by an actuator controlled by the computing device 815. In this way, if the environmental effect is that the image is too bright, for example due to daylight and sunshine if the field of view of the camera 130 is of an outdoor area or due to high artificial lighting if the field of view of the camera 130 is of an indoor area, the lens 810 may be filtered to be able to more dearly make out vehicle or other features of interest.

The computing device 815 may actuate an actuator 840 of a motor 845 that moves an actuated wiper blade 850 or arm 850 over and/or across the lens 810, which pushes water or other objects away from the lens 810 and/or away from the camera 130 and/or away from the camera unit 206. This may wipe rain away or may remove obstacles, such as bits of mud or animals (e.g., flies, bees, hornets) that might be sitting on the lens 810 (or another part of the camera 130 or camera unit 206) and causing an obstruction/occlusion of at least part of an image captured by the camera 130 (e.g., the environment-affected image received in step 720 of FIG. 7).

The computing device 815 may actuate an actuator 830 of a motor 835 that moves the camera 130 or camera unit 206 itself, for example by rotating the camera 130 or camera unit 206. If the environmental effect is that an obstacle is blocking or occluding an image captured by the camera 130 (e.g., the environment-affected image received in step 720 of FIG. 7), and the wiper/arm 850 cannot remove it (e.g., because the obstacle is not immediately on the lens but slightly in front) then the computing device 815 may actuate the actuator 830 and a motor 835 to move the camera 130 and/or camera unit 206 so that the field of view of the camera 130 changes to reduce (or minimize) how much of the field of view of the camera 130 is occluded or blocked by the object/obstacle.

The environmental sensors 820 include any sensors 132, and may include the camera 130 itself The camera 130 may be a sensor in that image detection or feature detection may be used to detect environmental conditions, for example by detecting raindrops, water puddles, snow, and the like to thereby identify an environmental condition of rain, flowing, snow, and so forth. The environmental sensors 820 (and therefore sensors 132) may include any of the following: accelerometer, air flow meter, air/wind speed indicator, altimeter, attitude indicator, barograph, barometer, bolometer, boost gauge, capacitive displacement sensor, carbon dioxide sensor, carbon monoxide detector, charge-coupled device, chemical field-effect transistor, chromatograph, colorimeter, compass, contact image sensor, current sensor, depth gauge, electrochemical gas sensor, electrolyte-insulator-semiconductor sensor, electronic nose, electro-optical sensor, exhaust gas temperature gauge, fiber optic sensors, flame detector, flow sensor, fluxgate compass, foot switches, force sensor, free fall sensor, galvanometer, gas detector, gas meter, Geiger counter, geophone, goniometers, gravimeter, gyroscope, hall effect sensor, hall probe, heart-rate sensor, heat flux sensor, liquid chromatograph, hot filament ionization gauge, hydrogen sensor, hydrogen sulfide sensor, hydrophone inclinometer, inertial reference unit, infrared point sensor, infra-red sensor, infrared thermometer, ionization gauge, ion-selective electrode, laser rangefinder, leaf electroscope, LED light sensor, linear encoder, liquid capacitive inclinometers, magnetic anomaly detector, magnetic compass, magnetometer, mass flow sensor, metal detector, microphone, microwave chemistry sensor, microwave radiometer, mood sensor, motion detector, multimeter, net radiometer, neutron detection, nitrogen oxide sensor, nondispersive infrared sensor, olfactometer, optode, oxygen sensor, particle detector, passive infrared sensor, pedometer, pH glass electrode, photodetector, photodiode, photoelectric sensor, photoionization detector, photomultiplier, photoresistor, photoswitch, phototransistor, phototube, piezoelectric accelerometer, GNSS position sensor, land-based triangulation position sensor, potentiometric sensor, pressure gauge, pressure sensor, proximity sensor, psychrometer, radiometer, rain gauge, rain sensor, reed switch, resistance temperature detector, resistance thermometer, respiration sensor, ring laser gyroscope, rotary encoder, rotary variable differential transformer, scintillometer, seismometer, silicon bandgap temperature sensor, smoke detector, snow gauge, soil moisture sensor, speech monitor, speed sensor, stream gauge, stud finder, sudden motion sensor, tachometer, tactile sensor, temperature gauge, thermistor, thermocouple, thermometer, tide gauge, tilt sensor, time pressure gauge, triangulation sensor, turn coordinator, ultrasonic thickness gauge, vibrating structure gyroscope, voltmeter, water meter, watt-hour meter, wavefront sensor, yaw rate sensor, and zinc oxide nanorod sensor, or some combination thereof.

While the camera unit 206 of FIG. 8 illustrates a directional camera and lens 810 rather than an omnidirectional camera, it should be understood that an omnidirectional camera may be used instead. Examples of types of omnidirectional cameras that may be used in this context include, but are not limited to, fisheye-lens cameras, wide-angle lens cameras, 360-degree dual-lens or multi-lens cameras, panorama cameras, cameras using image/panorama/360-degree stitching software, single camera rigs, multi-camera rigs, single-mirror camera housings, dual-mirror camera housings, multi-mirror camera housings, mosaic-based cameras, or combinations thereof.

FIG. 9 illustrates an exemplary computing system 900 that may be used to implement some aspects of the technology. For example, any of the computing devices, computing systems, network devices, network systems, servers, and/or arrangements of circuitry described herein may include at least one computing system 900, or may include at least one component of the computer system 900 identified in FIG. 9. The computing system 900 of FIG. 9 includes one or more processors 910 and memory 920. Each of the processor(s) 910 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 910 may include one or more cores, either integrated onto a single chip or spread across multiple chips connected or coupled together. Memory 920 stores, in part, instructions and data for execution by processor 910. Memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing some aspects of the subject technology for purposes of loading that software into memory 920.

Portable storage device 940 operates in conjunction with a portable non-volatile storage medium, such as a floppy disk, compact disk or Digital video disc, to input and output data and code to and from the computer system 900 of FIG. 9. The system software for implementing aspects of the subject technology may be stored on such a portable medium and input to the computer system 900 via the portable storage device 940.

The memory 920, mass storage device 930, or portable storage 940 may in some cases store sensitive information, such as transaction information, health information, or cryptographic keys, and may in some cases encrypt or decrypt such information with the aid of the processor 910. The memory 920, mass storage device 930, or portable storage 940 may in some cases store, at least in part, instructions, executable code, or other data for execution or processing by the processor 910.

Output devices 950 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 970. The printer may be inkjet, laserjet, thermal, or some combination thereof. In some cases, the output device circuitry 950 may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 950 may include any ports, plugs, antennae, wired or wireless transmitters, wired or wireless transceivers, or any other components necessary for or usable to implement the communication types listed above, such as cellular Subscriber Identity Module (SIM) cards.

Input devices 960 may include circuitry providing a portion of a user interface. Input devices 960 may include an alpha-numeric keypad, such as a keyboard, for inputting alpha-numeric and other information, or a pointing device, such as a mouse, a trackball, stylus, or cursor direction keys. Input devices 960 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 960 may include any ports, plugs, antennae, wired or wireless receivers, wired or wireless transceivers, or any other components necessary for or usable to implement the communication types listed above, such as cellular SIM cards.

Input devices 960 may include receivers or transceivers used for positioning of the computing system 900 as well. These may include any of the wired or wireless signal receivers or transceivers. For example, a location of the computing system 900 can be determined based on signal strength of signals as received at the computing system 900 from three cellular network towers, a process known as cellular triangulation. Fewer than three cellular network towers can also be used—even one can be used—though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 900 such as a router, modem, switch, hub, bridge, gateway, or repeater. These may also include Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 960 may include receivers or transceivers corresponding to one or more of these GNSS systems.

Display system 970 may include a liquid crystal display (LCD), a plasma display, an organic light-emitting diode (OLED) display, an electronic ink or “e-paper” display, a projector-based display, a holographic display, or another suitable display device. Display system 970 receives textual and graphical information, and processes the information for output to the display device. The display system 970 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 980 may include any type of computer support device to add additional functionality to the computer system. For example, peripheral device(s) 980 may include one or more additional output devices of any of the types discussed with respect to output device 950, one or more additional input devices of any of the types discussed with respect to input device 960, one or more additional display systems of any of the types discussed with respect to display system 970, one or more memories or mass storage devices or portable storage devices of any of the types discussed with respect to memory 920 or mass storage 930 or portable storage 940, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 900 of FIG. 9 can include those typically found in computer systems that may be suitable for use with some aspects of the subject technology and represent a broad category of such computer components that are well known in the art. That said, the computer system 900 of FIG. 9 can be customized and specialized for the purposes discussed herein and to carry out the various operations discussed herein, with specialized hardware components, specialized arrangements of hardware components, and/or specialized software. Thus, the computer system 900 of FIG. 9 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 900 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNU®, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 900 may also use a Basic Input/Output System (BIOS) or Unified Extensible Firmware Interface (UEFI) as a layer upon which the operating system(s) are run.

In some cases, the computer system 900 may be part of a multi-computer system that uses multiple computer systems 900, each for one or more specific tasks or purposes. For example, the multi-computer system may include multiple computer systems 900 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 900 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 920, the mass storage 930, the portable storage 940, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L9), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 910 for execution. A bus 990 carries the data to system RAM or another memory 920, from which a processor 910 retrieves and executes the instructions. The instructions received by system RAM or another memory 920 can optionally be stored on a fixed disk (mass storage device 930/portable storage 940) either before or after execution by processor 910. Various forms of storage may likewise be implemented as well as the necessary network interfaces and network topologies to implement the same.

While various flow diagrams provided and described above—including at least those in FIG. 2, FIG. 3, FIG. 4A, FIG. 4B, FIG. 5, FIG. 6, and FIG. 7—may show a particular order of operations performed by some embodiments of the subject technology, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 900 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method of reducing environmental effects in visual media captured by a camera, the method comprising:
storing a reference image captured by the camera during a first environmental condition;
receiving environmental information identifying a second environmental condition, wherein the second environmental condition affects visual media more than the first environmental condition;
receiving an environment-affected image from the camera, the environment-affected image captured by the camera during the second environmental condition;
identifying a difference between the environment-affected image and the reference image upon comparison;
identifying, based on the identified difference, an environmental effect affecting the environment-affected image;
identifying a component that mitigates the environmental effect; and
automatically activating the component, thereby mitigating the environmental effect.

2. The method of claim 1, wherein the difference is an image clarity difference, wherein the environmental effect is based on presence of water condensate on the camera, and wherein the component is a heating element mitigates the environmental effect by evaporating the water condensate on the camera.

3. The method of claim 1, wherein the difference is an image clarity difference, wherein the environmental effect is based on presence of a substance on the camera, and wherein the component is a heating element that mitigates the environmental effect by melting the substance that is on the camera.

4. The method of claim 1, wherein the difference is a brightness difference, wherein the environmental effect is based on time of day, and wherein the component is a light source that mitigates the environmental effect by illuminating a field of view of the camera.

5. The method of claim 1, wherein the difference is a brightness difference, wherein the environmental effect is based on time of day, and wherein the component is a light filter that mitigates the environmental effect by reducing an amount of light received by the camera.

6. The method of claim 1, wherein the difference is an image clarity difference, wherein the environmental effect is based on presence of precipitation on the camera, and wherein the component is an actuator of a motor that mitigates the environmental effect by moving a wiper element that wipes the precipitation from the camera.

7. The method of claim 1, wherein the difference is based on an occlusion of a field of view of the camera, wherein the environmental effect is based on presence of an object causing the occlusion, and wherein the component is an actuator of a motor that mitigates the environmental effect by moving the camera so as to reduce occlusion by the object in a field of view of the camera.

8. The method of claim 1 wherein the difference is based on an occlusion of a field of view of the camera, wherein the environmental effect is based on presence of an object causing the occlusion, and wherein the component is an actuator of a motor that mitigates the environmental effect by moving an element that pushes the object causing the occlusion away the camera.

9. The method of claim 1, wherein the environmental information identifying the second environmental condition is received from one or more sensors.

10. The method of claim 1, wherein the environmental information identifying the second environmental condition is received over a network from a server associated with a weather service.

11. The method of claim 1, wherein the camera is an omnidirectional camera.

12. A system for reducing environmental effects in visual media, the system comprising:
a memory that stores a reference image captured by a camera during a first environmental condition;
a camera connector communicatively coupled to a camera that captures an environment-affected image during a second environmental condition, wherein the second environmental condition affects visual media more than the first environmental condition;
a processor that executes instructions, wherein execution of the instructions by the processor:
identifies a difference between the environment-affected image and the reference image upon comparison,
identifies, based on the difference, an environmental effect affecting the environment-affected image, and
identifies that a component mitigates the environmental effect; and
a component connector communicatively coupled to the component, wherein the component connector automatically activates the component in response to identifying that the component mitigates the environmental effect, thereby mitigating the environmental effect.

13. The system of claim 12, wherein the difference is an image clarity difference, wherein the environmental effect is based on presence of a substance on the camera, and wherein the component is a heating element that mitigates the environmental effect by heating the substance on the camera from a first state of matter to a second state of matter.

14. The method of claim 12, wherein the difference is a brightness difference, wherein the environmental effect is based on brightness of an area in the field of view of the camera, and wherein the component is a light source illuminating the area.

15. The method of claim 1, wherein the difference is a brightness difference, wherein the environmental effect is based on brightness of an area in the field of view of the camera, and wherein the component is a light filter reducing an amount of light received by the camera.

16. The system of claim 12, wherein the difference is based on an occlusion of a field of view of the camera, wherein the environmental effect is based on presence of an object causing the occlusion, and wherein the component is an actuator of a motor whose actuation causes motion that reduces the occlusion.

17. A method of reducing environmental effects in visual media captured by a camera, the method comprising:
receiving an environment-affected image from the camera, the environment-affected image captured by the camera during the second environmental condition;
identifying an environmental effect affecting the environment-affected image;
identifying a component that mitigates the environmental effect; and
automatically activating the component, thereby mitigating the environmental effect.

18. The method of claim 17, wherein the environmental effect is based on presence of a substance on the camera, wherein the component is a heating element that mitigates the environmental effect by heating the substance on the camera from a first state of matter to a second state of matter.

19. The method of claim 17, wherein the difference is based on an occlusion of a field of view of the camera, wherein the environmental effect is based on presence of an object causing the occlusion, and wherein the component is an actuator of a motor whose actuation causes motion that reduces the occlusion.

20. The method of claim 17, wherein the difference is a brightness difference, wherein the environmental effect is based on brightness of an area in the field of view of the camera, and wherein the component modifies an amount of light received by the camera.
